(19) United States
(12) Patent Application Publication
(10) Pub. No.: US 2026/0337003 A1
(43) Pub. Date: Oct. 29, 2026

(54) SODA CARBONATION AND DISPENSATION SYSTEM AND METHOD

(71) Applicants: Hunter Abraham, Slidell, LA (US); Martin J. Abraham, III, Slidell, LA (US)

(72) Inventors: Hunter Abraham, Slidell, LA (US); Martin J. Abraham, III, Slidell, LA (US)

(21) Appl. No.: 19/466,101

(22) Filed: Jan. 30, 2026

Related U.S. Application Data
(63) Continuation-in-part of application No. 18/507,947, filed on Nov. 13, 2023, now Pat. No. 12,577,097.
Application No. 18/507,947 is a continuation of application No. 17/033,069, filed on Sep. 25, 2020, now Pat. No. 11,897,749.
(60) Provisional application No. 62/906,065, filed on Sep. 25, 2019.

(51) Int. Cl. B67D 1/08; B01F 23/236; B67D 1/00; B67D 1/14

(52) U.S. Cl. CPC B67D 1/0857; B01F 23/2362; B67D 1/0027; B67D 1/0031; B67D 1/0061; B67D 1/0862; B67D 1/1422; B67D 1/1472; B67D 2210/0006; B67D 2210/00139

(57) ABSTRACT

A soda dispenser including: a stem; a flow restrictor including a plurality of holes provided around a perimeter of the flow restrictor; and a faucet fixed to a second end of the stem, wherein the stem is configured to receive carbonated water at a first end of the stem, wherein the flow restrictor is at least partially within the second end of the stem and is configured to receive the carbonated water into a hollow interior of the flow restrictor from the stem through an opening on a first end of the flow restrictor, and wherein the plurality of holes are configured to allow the carbonated water received into the hollow interior of the flow restrictor to exit the flow restrictor into a gap formed between an outer surface of the flow restrictor and an inner surface of the stem.

### CROSS REFERENCE TO RELATED APPLICATIONS

This application is a continuation in part of U.S. patent application Ser. No. 18/507,947, filed on Nov. 13, 2023, which is a continuation application of U.S. application Ser. No. 17/033,069 (now U.S. Pat. No. 11,897,749), which was filed Sep. 25, 2020, which claims priority to U.S. Provisional Patent Application No. 62/906,065, filed Sep. 25, 2019, the entirety of which are incorporated herein by reference.

### BACKGROUND

The present disclosure relates to carbonated beverage dispensation systems, commonly called soda fountains, which prepare and dispense carbonated beverages on-demand. More specifically, the present disclosure is directed to a system and method for making carbonated water, conveying chilled, low pressure carbonated water and flavored syrup to a dispensing tower, and mixing the carbonated water and syrup as they are dispensed into a container.

Carbonated beverages are typically prepared when pressurized carbonated water and flavored syrup are held within separate tanks and then mixed as they are pumped through a single discharge spout or faucet. A user selects the beverage by pressing a button or activating a lever below a discharge spout, the corresponding flavored syrup is drawn from its reservoir and carbonated water is drawn from its reservoir, the fluids are mixed en route to the discharge spout, and the mixed beverage flows into the target container. A typical system mixes the carbonated water and syrup in a set ratio to distribute a mixed beverage of desired flavor and consistency. The ratio is adjusted depending on the beverage type and consumer preference.

Carbonation is a desirable characteristic of fountain beverages such as soda pop, cocktail mixers, beer and sparkling wines. The carbon dioxide bubbles convey an aromatic sensation as the beverage is lifted to the nose, which creates a heightened perception of flavor. Carbonation also creates an appealing texture or notion of freshness as the bubbles tingle one's mouth. It is well known that a carbonated beverage loses its appeal when carbonation is expelled and the beverage “goes flat”.

With current beverage fountain systems, soda water loses carbonation because it becomes stagnant and it is not continuously chilled. High pressure and high temperature dispensation also cause excessive foaming when the beverage is dispensed, which causes rapid carbonation loss. Consequently, typical fountain beverages lose their appeal soon after they are dispensed.

Accordingly, there is a need for a soda carbonation and dispensation system and method that helps preserves carbonation in fountain beverages after they are dispensed. The purpose of this disclosure is to maintain a constant carbonation level within the system and eliminate excessive foaming as the beverage is dispensed.

U.S. Pat. No. 7,389,647 directed to refrigeration blocks is incorporated by reference, as are U.S. Pat. Nos. 8,347,646, 8,616,020, and 9,366,475, all directed to temperature-controlled beverage dispensation systems.

### SUMMARY

The following embodiments thereof are described and illustrated in conjunction with systems, machines and methods which are meant to be exemplary and illustrative, and not limiting in scope. In one or more embodiments, one or more of the above-described problems have been reduced or eliminated, while other embodiments are directed to other improvements.

Provided is a soda carbonation and dispensation system and method that solves the problem of rapid carbonation loss of fountain beverages by maintaining constant carbonation through continuous circulation, achieving a constant low fluid temperature, and delivering the carbonated water and flavored syrup to the dispensing faucet at a low pressure to reduce foaming.

In accordance with one or more embodiments of the disclosure, a soda carbonation and dispensation system is provided which is operable to infuse water with carbon dioxide to create first-stage carbonated water. A first pump and motor assembly is operable to draw uncarbonated water through a chiller and into a first carbonator tank. A pressurized carbon dioxide source is connected to the first carbonator tank.

A second carbonator tank is provided which includes a carbonation stone that facilitates creation of second-stage carbonated water. A second pump and motor assembly is operable to draw carbonated water from the first carbonator tank and the second carbonator tank, thereby mixing the first- and second-stage carbonated water. The second pump and motor assembly pumps the mixed carbonated water through a cold block and back into the first and second carbonator tanks. A third pump and motor assembly is provided which draws carbonated water from the second carbonator tank and injects it into a carbonated water delivery loop which is connected to a beverage dispensing tower.

An electrical controller is connected to the first and second pump and motor assemblies and the first carbonator tank, which detects the fluid level of the first carbonator tank and controls the operation of the first and second pump and motor assembly to maintain a set fluid level in the first carbonator tank. The electrical controller also circulates first- and second-stage carbonated water through a chiller system to create an optimal mixture of carbonated water and maintain it at a predetermined temperature.

A flavored syrup chilling and supply system is provided which includes a plurality of sealer bags or similar vessels which contain flavored syrup. A set of pump assemblies are operable to pump the syrup into a chilled delivery line system connected to the beverage dispensing tower. A plurality of flow control regulators are operable to control the flow rate and pressure of the syrup as it is pumped through the delivery line system.

A brix capacitor is connected to the carbonated water delivery loop and the syrup chilling and supply system. The brix capacitor is operable regulate the flow of carbonated water and syrup to the faucets in the dispensing tower such that syrup is delivered to each faucet at a lower pressure than the pressure of the carbonated water. The brix capacitor also provides for a carbonated water return to the suction side of the third pump and motor assembly.

Carbonated water is continuously circulated through the carbonated water delivery loop to maintain a constant low temperature and consistent carbonation level. The syrup and carbonated water are mixed to create a carbonated beverage when the faucets are opened. The pressures of the syrup and carbonated water are kept low to facilitate laminar flow of the beverage into the target container.

According to an aspect of the disclosure, a soda dispenser includes: a stem including: a first opening on a first end of the stem; a second opening on a second end of the stem; and a central bore connecting the first opening of the stem and the second opening of the stem; and a flow restrictor including: an opening on a first end of the flow restrictor; a cap on a second end of the flow restrictor; a central portion between the first end of the flow restrictor and the second end of the flow restrictor, wherein the central portion and the cap define a hollow interior of the flow restrictor; and a plurality of holes provided around a perimeter of the flow restrictor; and a faucet fixed to the second end of the stem, wherein the stem is configured to receive carbonated water at the first end of the stem, wherein the flow restrictor is at least partially within the second end of the stem and is configured to receive the carbonated water into the hollow interior of the flow restrictor from the stem through the opening on the first end of the flow restrictor, and wherein the plurality of holes are configured to allow the carbonated water received into the hollow interior of the flow restrictor to exit the flow restrictor into a gap formed between an outer surface of the flow restrictor and an inner surface of the stem.

The soda dispenser may further include: a housing; at least one source of carbonated water; and a soda delivery line connected to the at least one source of carbonated water, wherein the stem is attached to the housing and receives the carbonated water from the soda delivery line, and wherein the faucet includes a first input configured to receive the carbonated water from the stem.

The soda dispenser may further include at least one source of syrup, wherein the faucet includes an input connected to the at least one source of syrup.

The soda dispenser may further include at least one source of carbonated water and at least one source of syrup, wherein the stem is connected to the at least one source of carbonated water, and wherein the faucet includes a first input connected to the stem and configured to receive the carbonated water from the stem, and a second input connected to the at least one source of syrup.

The syrup may be delivered to the faucet at a lower pressure than a pressure that the carbonated water is delivered to the faucet.

The faucet may include a valve and a flow guide with an exterior and an interior.

The syrup and the carbonated water may be mixed on the interior of the flow guide when the valve is opened.

The plurality of holes may be evenly distributed around the perimeter of the flow restrictor.

A number of the plurality of holes may be 3.

A number of the plurality of holes may be 6.

According to an aspect of the disclosure, a soda dispenser includes: a stem including a central bore, wherein the stem is configured to receive carbonated water; a flow restrictor inside the central bore, the flow restrictor including an opening facing an interior of the stem and a plurality of holes distributed around a perimeter of the flow restrictor; and a faucet attached to an end of the stem downstream from the flow restrictor, wherein the flow restrictor is configured to restrict a flow of carbonated water through the stem by partially blocking the central bore, and wherein the plurality of holes are configured to allow the carbonated water received into the flow restrictor through the opening facing the interior of the stem to return to the central bore.

According to an aspect of the disclosure, a soda dispenser includes: at least one source of carbonated water; at least one source of syrup; a housing; a soda delivery line connected to the at least one source of carbonated water, a stem including: a first opening on a first end of the stem, wherein the first opening is connected to the soda delivery line; a second opening on a second end of the stem; and a central bore connecting the first opening of the stem and the second opening of the stem; and a flow restrictor including: an opening on a first end of the flow restrictor; a cap on a second end of the flow restrictor; a central portion between the first end of the flow restrictor and the second end of the flow restrictor, wherein the central portion and the cap define a hollow interior of the flow restrictor; and a plurality of holes provided around a perimeter of the flow restrictor; and a faucet fixed to the second end of the stem, wherein the flow restrictor is at least partially within the stem and is configured to receive, from the stem, carbonated water, and wherein the plurality of holes are configured to allow the carbonated water to move from the hollow interior of the flow restrictor into a gap formed between an outer surface of the flow restrictor and an inner surface of the stem.

### BRIEF DESCRIPTION OF THE DRAWINGS

FIG. 1 is a perspective view of a complete soda rack in accordance with one or more embodiments of the disclosure.

FIG. 2 is a diagram of a complete soda rack in accordance with one or more embodiments of the disclosure.

FIG. 3 is a diagram of a carbonated water circulation system in accordance with one or more embodiments of the disclosure.

FIG. 4 is an overhead view of an arrangement of carbonated water pump and motor assemblies and carbonator tanks in accordance with one or more embodiments of the disclosure.

FIG. 5 is an overhead view of an arrangement of carbonated water pump and motor assemblies and carbonator tanks with subcomponents labeled in accordance with one or more embodiments of the disclosure.

FIG. 6 is an electrical diagram of the controller in accordance with one or more embodiments of the disclosure.

FIG. 7 is a diagram of the brix capacitor in accordance with one or more embodiments of the disclosure.

FIG. 8 is a perspective view and a top cross-sectional view of the brix capacitor in accordance with one or more embodiments of the disclosure.

FIG. 9 is a multi-perspective view of the brix capacitor.

FIG. 10 is a diagram of the soda dispensing tower in accordance with one or more embodiments of the disclosure.

FIG. 11 is a perspective view of the soda dispensing tower in accordance with one or more embodiments of the disclosure.

FIG. 12 is a multi-perspective view and cross section of a faucet in accordance with one or more embodiments of the disclosure.

FIG. 13 is a front view and cross section of a faucet in the closed position in accordance with one or more embodiments of the disclosure.

FIG. 14 is a plan view of a stem and flow restrictor according to one or more embodiments of the disclosure.

FIG. 15 is a front, perspective view of a stem and flow restrictor according to one or more embodiments of the disclosure.

FIG. 16 is a rear, perspective view of a stem and flow restrictor according to one or more embodiments of the disclosure.

FIG. 17 is a plan view and a cross-sectional view of an assembled stem and flow restrictor according to one or more embodiments of the disclosure.

FIG. 18 is a perspective view of an assembled stem and flow restrictor installed on a soda dispensing tower according to one or more embodiments of the disclosure.

### DETAILED DESCRIPTION

For a further understanding of the nature and function of the embodiments, reference should be made to the following detailed description. It will be readily appreciated that the embodiments are well adapted to carry out and obtain the ends and features mentioned as well as those inherent herein. It is to be understood, however, that the present disclosure is embodied in various forms. Therefore, persons of ordinary skill in the art will realize that the following disclosure is illustrative only and not in any way limiting, as the specific details disclosed herein provide a basis for the claims and a representative basis for teaching to employ the present disclosure in virtually any appropriately detailed system, structure or manner. It should be understood that the devices, materials, methods, procedures, and techniques described herein are presently representative of one or more embodiments. Other embodiments of the disclosure will readily suggest themselves to such skilled persons having the benefit of this disclosure.

In accordance with one or more embodiments of the disclosure, a soda carbonation and dispensation system is provided. In an embodiment, the system includes subsystems including a water carbonation and circulation system, a flavored syrup delivery system, and a beverage dispensation system.

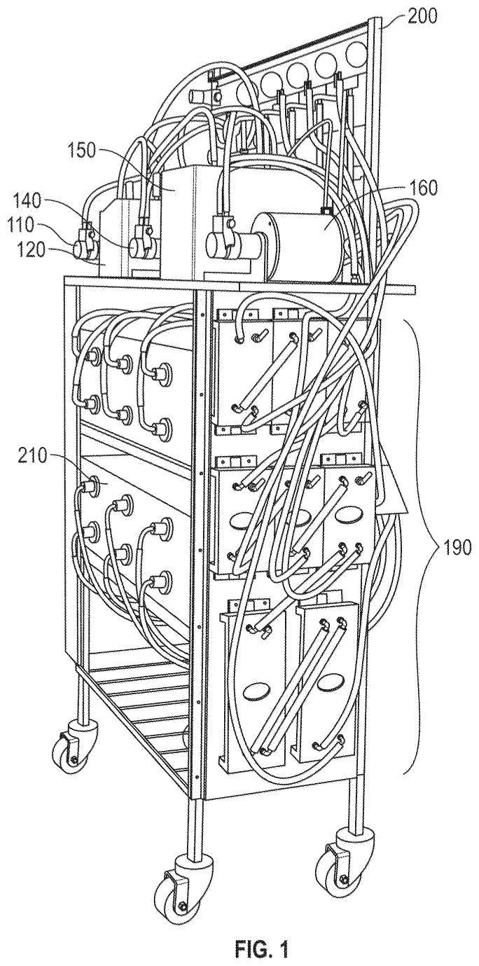

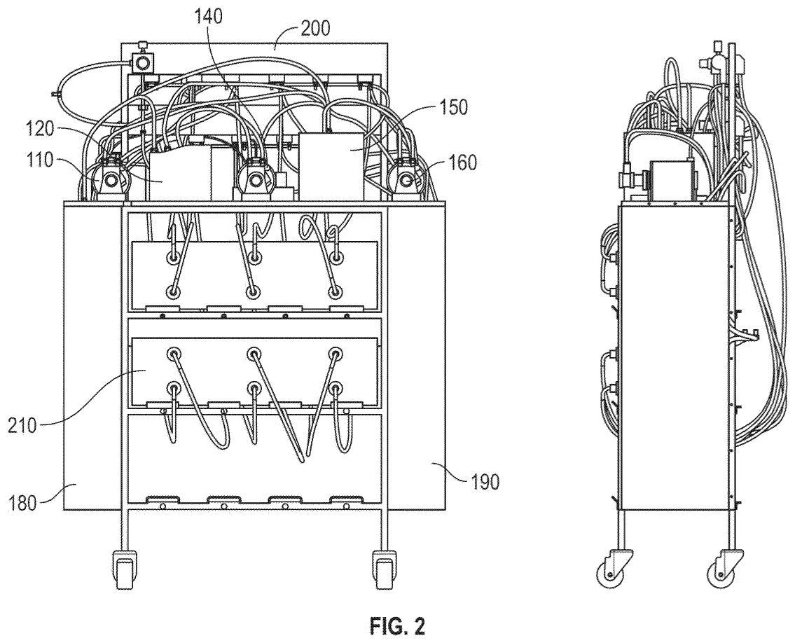

FIG. 1 shows an embodiment of a water carbonation and circulation system and a flavored syrup delivery system of the disclosure, including a carbonator pump and motor 110, a first carbonator tank 120, a circulating pump and motor 140, a second carbonator tank 150, a tower circulation pump and motor 160, a right chiller bank 190, syrup sources 210, a syrup pump 260, and syrup regulators 270, all housed upon a pump rack 200. FIG. 2 shows a diagram of a front view and a side view of pump rack 200 with the aforementioned components and the addition of left chiller bank 180. Left chiller bank 180 and right chiller bank 190 include a plurality of cold water blocks 220 and cold syrup blocks 230.

In an exemplary embodiment, carbonator pump and motor 110 and circulating pump and motor 140 are 100 gallon-per-hour pumps such as the Procon #103B100F31BB and ⅓ horsepower motors such as the Nidec #5-557297. In an exemplary embodiment, tower circulation pump and motor 160 is a 35-50 gallon-per-hour stainless steel pump such as the Procon #103B35F31BB and a ⅓ horsepower motor such as the Nidec #5-557297. In an exemplary embodiment, cold water blocks 220 and cold syrup blocks 230 are of the type disclosed in U.S. Pat. No. 7,389,647 issued to Martin J. Abraham, III on Jun. 24, 2008 (U.S. Pat. No. 7,389,647 is incorporated herein by reference as if set forth in full below). Cold water blocks 220 are the same or similar in type as HTG MFG-HTGN023A-10. Cold syrup blocks 230 are the same or similar in type as HTG MFG-HTGN012A-08-1032. In an exemplary embodiment, syrup pumps 260 are pneumatic bag-in-box pumps such as the Xylem Flojet T5000-515 and are operable to discharge syrup from 20 pounds per square inch to 90 pounds per square inch. In an exemplary embodiment, syrup regulators 270 are the same or similar type as Tap Rite T5261SN.

First carbonator tank 120 may include a pressure relief valve 250, and an internal sensor and flotation device 280 which is electrically connected to controller 130. Internal sensor and flotation device 280 may measure the water level in first carbonator tank 120 and send an electrical signal to controller 130 when the water level reaches a predetermined high level and falls below a predetermined low level. A spray nozzle is inserted into the bottom of first carbonator tank 120 to connect a pressurized carbon dioxide source to infuse water with carbon dioxide at a pressure of approximately fifty pounds per square inch. In an exemplary embodiment, first carbonator tank 120 is the same or similar in type as Manitowoc carbonation tank #E400397, and internal sensor and flotation device 280 is the same or similar in type as Manitowoc float #16-21-15.

In an embodiment, second carbonator tank 150 may include a pressure relief valve 250 and a carbonation stone 290. In an exemplary embodiment, pressure relief valve 250 is a check valve such as the John Guest JG3/8SCV or the Valve Check C103-5-1M-100. In an alternative embodiment. Valve Check C103-5-1M-60 is used. In an exemplary embodiment, carbonation stone 290 is the same or similar in type as Glacier Tanks CBST-R150-006. In an exemplary embodiment, second carbonator tank 150 is the same or similar type as Sharpsville D0077693-C, and has a volume that exceeds the volume of first carbonator tank by approximately one-half gallon.

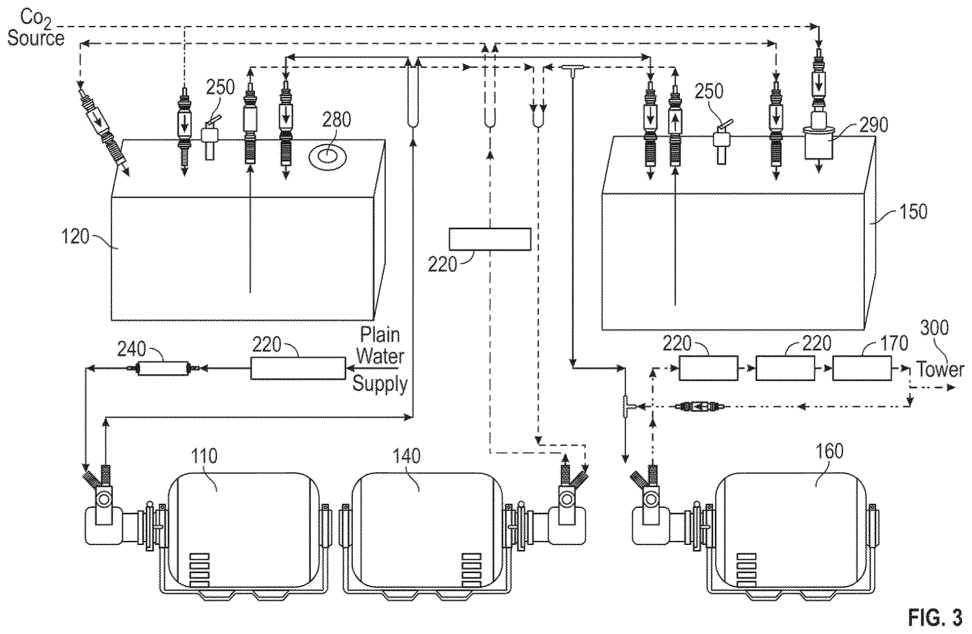

As depicted in the flow diagram of FIG. 3, the suction of carbonator pump and motor 110 is connected to an uncarbonated source of fresh water and operable to draw water through at least one cold water block 220 and a water pressure regulator 240. The discharge of carbonator pump and motor 110 is connected to first carbonator tank 120.

First carbonator tank 120 is also connected to the suction of circulating pump and motor

140 so that carbonated water is drawn from first carbonator tank 120 and pumped into second carbonator tank 150. First carbonator tank 120 is also connected to cold water blocks 220 so that it may receive refrigerated water from cold water blocks 220.

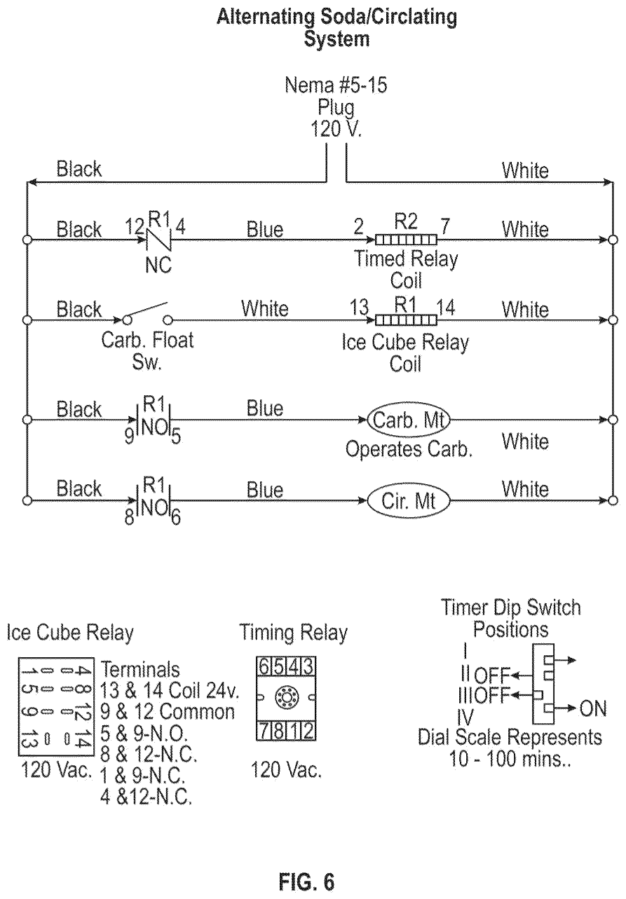

Controller 130 is an electrical circuit which is engineered to activate and deactivate carbonator pump and motor 110 and circulating pump and motor 140 depending on the water level in first carbonator tank 120 as further described herein. An electrical diagram of controller 130 is provided in FIG. 6.

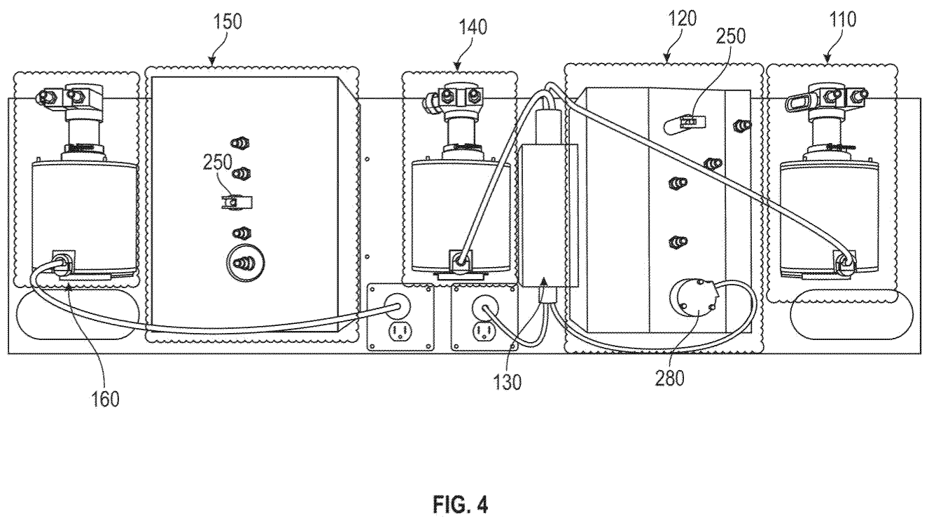

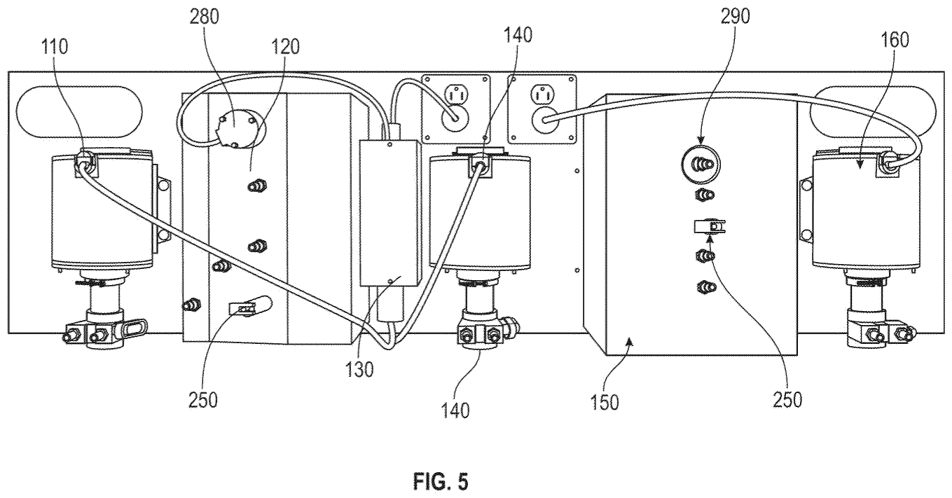

An exemplary arrangement of carbonator pump and motor 110, first carbonator tank 120, controller 130, circulating pump and motor 140, second carbonator tank 150 and tower circulation pump and motor 160 is shown in FIGS. 4 and 5. In one or more embodiments, second carbonator tank 150 is connected to the discharge of carbonator pump and motor 110 so it may receive uncarbonated fresh water. Second carbonator tank 150 is also connected to the suction and discharge of circulating pump and motor 140 so that circulating pump and motor 140 may circulate carbonated water from second carbonator tank 150, through cold water blocks 220, and back into second carbonator tank 150. Second carbonator tank 150 is also connected to tower circulation pump and motor 160 so that carbonated water is pumped to brix capacitor 170 and beverage dispensing tower 300.

In an exemplary embodiment, controller 130 is operable to activate carbonator pump and motor 110 and circulating pump and motor 140, and allow them to operate until first carbonator tank 120 reaches a predetermined high level, at which time controller 130 deactivates carbonator pump and motor 110 to stop adding water to the system. Controller 130 may continue to run circulating pump and motor 140 to make carbonated water.

In an embodiment, carbonation stone 290 within second carbonator tank 150 is connected to a pressurized carbon dioxide source to infuse carbonated water within second carbonator tank 150 with carbon dioxide at a pressure of approximately fifty pounds per square inch. In an exemplary embodiment, carbon dioxide diffuses through carbonation stone 290 into the water creating very small carbon dioxide bubbles which dissolve into the water. The carbonation level of the carbonated water is adjustable by altering the run-time of circulating pump and motor 140.

As shown in FIG. 3, the suction of tower circulation pump and motor 160 is connected to second carbonator tank 150, and the discharge of tower circulation pump and motor 160 is connected to brix capacitor 170 such that during operation, tower circulation pump and motor 160 sucks carbonated water from second carbonator tank 150 and pumps it through cold water blocks 220 and into manifold 171 of brix capacitor 170, where it is distributed to individual faucets 310 within beverage dispensing tower 300 and circulated back to tower circulation pump and motor 160 to achieve continuous, chilled circulation.

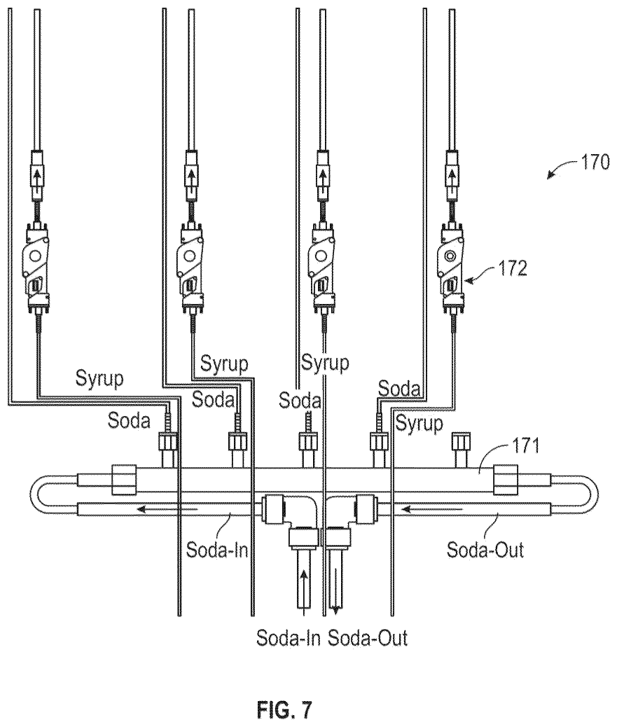

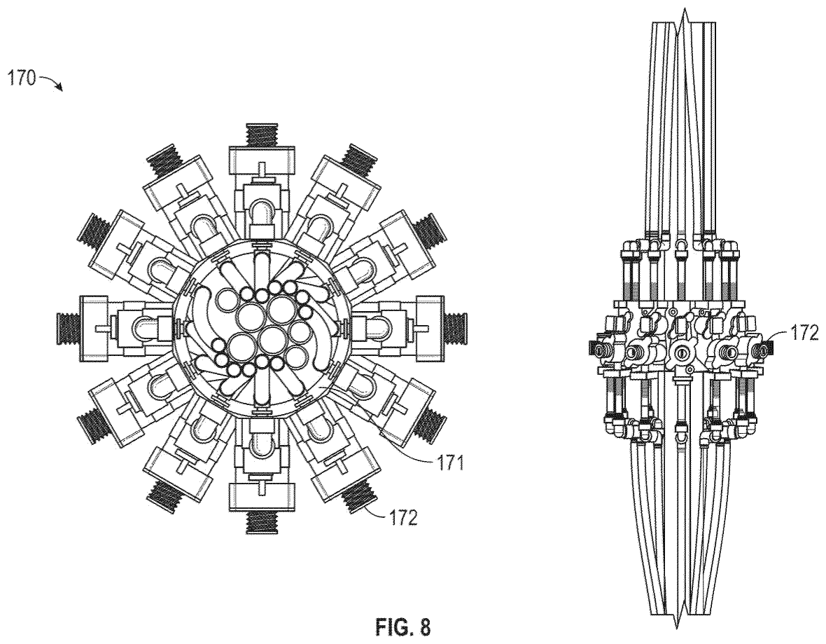

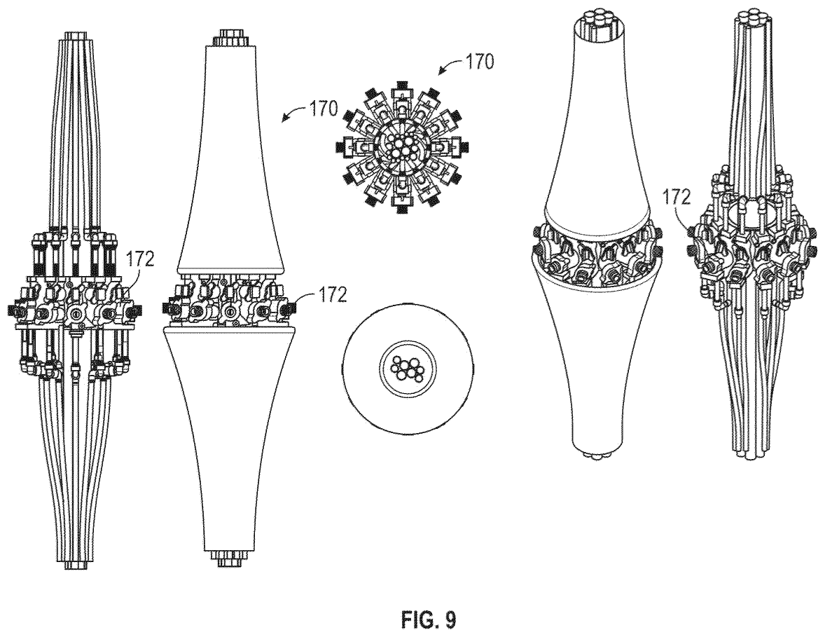

An exemplary flow diagram of brix capacitor 170 is shown in FIG. 7. Exemplary embodiments of brix capacitor 170 are shown in FIGS. 8 and 9. In an embodiment, brix capacitor 170 houses manifold 171 which receives chilled water pumped from tower circulation pump and motor 160 and through cold water blocks 220. In one or more embodiments, manifold 171 is circular and provides a mounting structure for flow control valves 172. In an exemplary embodiment, flow control valves 172 are the same or of a similar type as Schroder America #639-0034 or Schroder America #639-0050.

A plurality of discharge nozzles is displaced on manifold 171, each providing an independent carbonated water supply line to each faucet 310. In an exemplary embodiment, a carbonated water supply line between brix capacitor 170 and each faucet 310 is approximately 72 inches in length, with an inner diameter of 0.117 inches and an outer diameter of 0.1875 inches.

As shown in FIG. 7, manifold 171 within brix capacitor 170 may also discharge carbonated water into a return line whereby it may flow back into the suction line of tower circulation pump and motor 160, which then recirculates the carbonated water through cold water blocks 220 and manifold 171 of brix capacitor 170. Such recirculation helps maintain a consistent and desirable carbonation level in three ways. First, the recirculated carbonated water is mixed with freshly carbonated water on the suction side of tower circulation pump and motor 160. Second, the recirculated carbonated water is continuously refrigerated as it is pumped through cold water blocks 220. Low temperature fluctuation promotes a stable carbonation level. Third, the recirculated carbonated water does not stagnate, which eliminates a typical cause of carbonation loss.

As shown in FIGS. 1 and 2, a flavored syrup circulation system includes pump rack 200, syrup pumps 260, syrup regulators 270 and cold syrup blocks 230. In an embodiment, a plurality of syrup sources 210 containing a variety of flavored syrups are disposed on pump rack 200. In an exemplary embodiment, syrup sources 210 are sealer bags which are commonly known in the industry.

In an embodiment, each syrup source 210 is connected to a corresponding syrup pump 260 which is operable to pump syrup out of syrup source 210 and discharge the syrup to brix capacitor 170. Syrup regulators 270 are operable to control the flow rate and pressure of the syrup.

As depicted in FIG. 7, syrup flows into one of a plurality of flow control valves 172 disposed throughout brix capacitor 170. Syrup then flows from brix capacitor 170 into beverage dispensing tower 300 and to one of a plurality of faucets 310. Each flow control valve 172 is independently adjustable to manipulate the flow rate and pressure of the syrup.

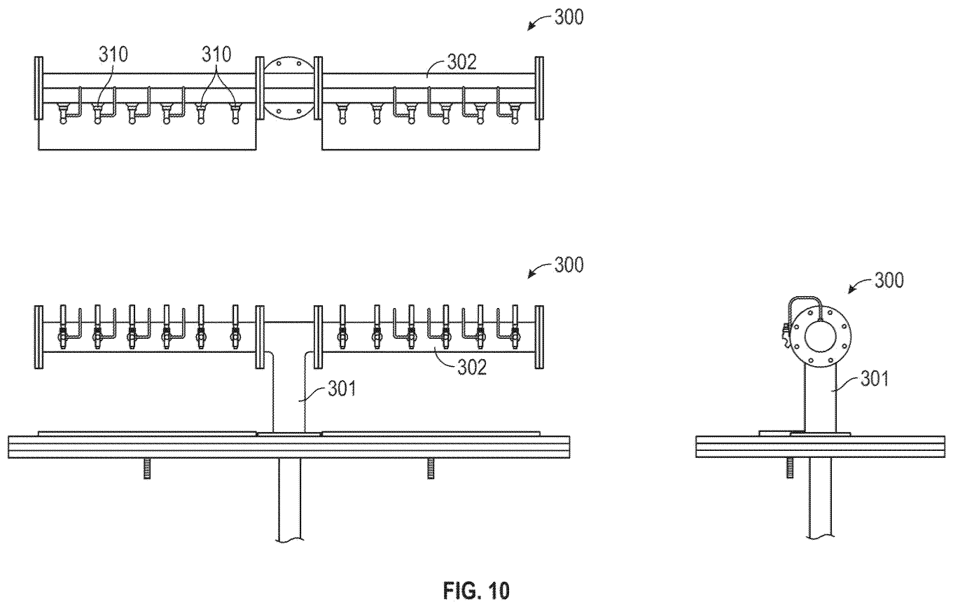

As shown in FIGS. 10 and 11, the beverage dispensation system includes beverage dispensing tower 300 and a plurality of soda faucets 310. In an embodiment, beverage dispensing tower 300 includes a vertical housing 301 which is perpendicularly connected to a lateral housing 302 which extends in equal, opposing axial directions to form a “tee”. The soda delivery lines and syrup delivery lines are housed within vertical housing 301 and lateral housing 302 as they run from brix capacitor 170 to faucets 310, which are disposed along the lateral housing of beverage dispensing tower 300. As shown in FIG. 7, one soda delivery line and one syrup delivery line is each connected to a dedicated faucet 310.

In an exemplary embodiment, beverage dispensing tower 300 may incorporate a chilling system similar to or any combination of those described in U.S. Pat. Nos. 8,347,646, 8,616,020, and 9,366,475, issued to Martin J. Abraham, III on Jun. 14, 2016, all of which are incorporated herein by reference as if set forth in full below.

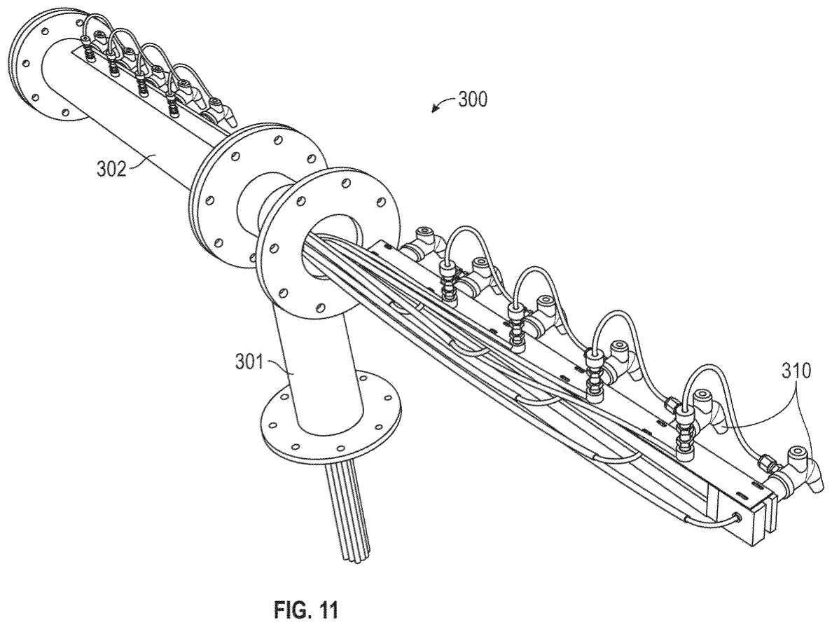

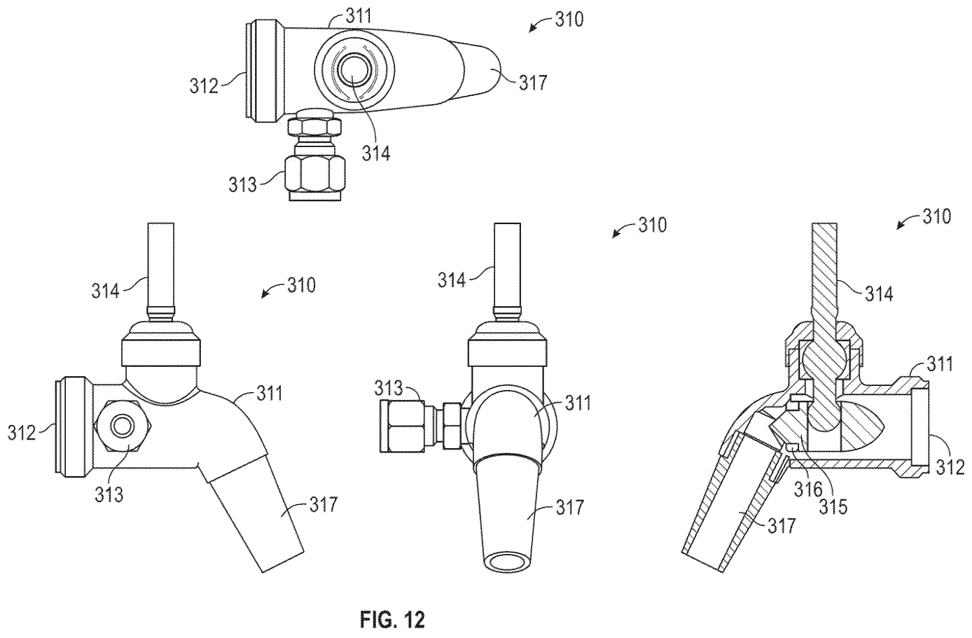

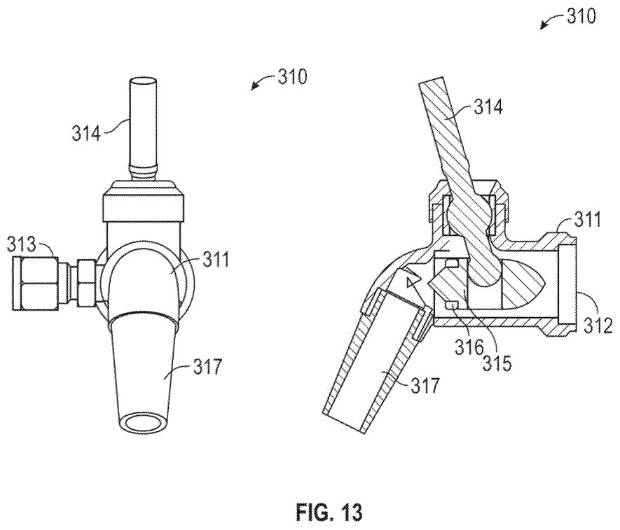

As shown in FIGS. 12 and 13, faucet 310 includes outer housing 311, carbonated water injection port 312, syrup injection port 313, handle lever 314, internal plunger 315, seat 316 and conical flow guide 317. Soda is circulated into carbonated water injection port 312. Likewise, syrup is injected into syrup injection port 313. In an exemplary embodiment, faucet 310 is closed when handle lever 314 is rocked such that internal plunger 315 is pressed against seat 316 to create a seal. Faucet 310 is opened when handle lever 314 is rocked such that internal plunger 315 is unseated. Pressurized soda and syrup are mixed as they flow through conical flow guide 317 into a target container.

In an embodiment, each faucet 310 may be connected to the tower 300 via attachment to a stem 400. As shown in FIGS. 14-18, the stem 400 may be fixed to the dispensing tower 300. In an embodiment, the stem 400 may include external threads 402 and may be screwed into a threaded opening in the dispending tower 300. The stem 400 may include a coupling flange 405 operable to receive a faucet 310. In an embodiment, an internal portion of the flange 405 may include internal threading, and the faucet 310 may be attached to the stem 400 via a threaded end portion. However, the disclosure is not limited to these embodiments, and the faucet 310 may be attached to the flange 405 in ways other than screw-in attachment.

A first end of the stem 400 may be configured to be inserted into the dispensing tower 300 and may include an opening 430 operable to connect to a soda delivery line and to receive pressurized soda water from the soda delivery line. In an embodiment, the opening 430 is 0.375 inches wide, but the disclosure is not limited thereto. A second end of the stem 400 may face away from the dispensing tower 300. The stem 400 may include a central bore 435 beginning at the opening 430 and extending through the length of the stem 400. In an embodiment, the stem 400 may be 4.125 inches long, but the disclosure is not limited thereto.

The stem 400 may include a first portion 404 and a second portion 406. In an embodiment, the first portion is 3.625 inches long, and the second portion is 0.5 inches long. In an embodiment, the diameter d1 of the central bore 435 in the first portion 404 may be smaller than the diameter d2 of the central bore in the second portion 406. In an embodiment, the diameter d1 may be 0.375 inches and the diameter d2 may be 0.625 inches, but the disclosure is not limited thereto. Despite the reference to diameters, the central bore is not limited to a circular cross-section, and it may have other non-circular or polygonal shapes. At the junction between the first portion 404 and the second portion 406, a ledge may be formed, and an O-ring 415 may be provided on the ledge. In an embodiment, the O-ring is made of rubber or silicon. Internal threads 417 may be provided along a portion of the second portion 406 closest to the first portion 404. The internal threads 417 may be configured to receive a threaded portion 414 of a flow restrictor 410.

The flow restrictor 410 may be a cylindrical cap or plug configured to screw into the second portion 406 of the stem 400, however the disclosure is not limited thereto, and the flow restrictor 410 may be shapes other than a cylinder. The flow restrictor 410 may extend for most of the length of the second portion 406. An outer diameter of the flow restrictor 410 may be less than an inner diameter of the second portion 406 of the stem 400, thereby forming a gap 450 between the flow restrictor 410 and the interior surface of the stem 400 when the flow restrictor 410 is secured within the stem 400. In an embodiment, the gap 450 between the exterior of the flow restrictor 410 and the interior of the stem 400 may be 0.076 inches wide, and the flow restrictor 410 may be 1.25 inches long and may have an outer diameter or width of 0.5 inches, but the disclosure is not limited thereto.

The flow restrictor 410 may be a hollow cylinder with an opening 411 configured to face toward the interior of the stem 400, and an end cap 440 configured to face toward a faucet 310 mounted on the stem 400. In a configuration where carbonated water is supplied to the stem, the faucet 310 is downstream from the flow restrictor 410. In an embodiment, the inner diameter of the hollow interior of the flow restrictor 410 may be 0.387 inches, but the disclosure is not limited thereto. An interior space 413 may be formed by the body of the flow restrictor 410 and the end cap 440. The body of the flow restrictor 410 and the end cap 440 may be a unitary structure, but the disclosure is not limited thereto. In an embodiment, an exterior surface of the end cap 440 may include a slot or other recess to facilitate screwing the flow restrictor 410 into the stem 400.

The flow restrictor 410 may include a plurality of holes 412 evenly distributed around a circumference of the flow restrictor 410. The holes 412 may be positioned close to the threaded portion 414 such that the holes 412 open into the gap 450 formed between the flow restrictor 410 and the inner surface of the second portion 406 of the stem 400. In an embodiment, the holes 412 may be 0.3125 inches from the threaded portion 414, but the disclosure is not limited thereto. In an embodiment, three holes 412 are provided, spaced 120° apart around the circumference of the flow restrictor 410. In another embodiment, six holes 412 are provided, spaced 60° apart around the circumference of the flow restrictor 410. However, the disclosure is not limited to embodiments with three or six holes 412, and other numbers of holes 412 may be provided. In an embodiment, the holes 412 are 0.02 inches wide, but the disclosure is not limited thereto.

In operation, the stem 400, when installed in the dispensing tower 300, is configured to receive pressurized soda water from a soda delivery line through the opening 435. The pressurized soda water proceeds through the central bore 435 and into the flow restrictor 410. The pressurized soda water then exits the interior of the flow restrictor 410, through the holes 412, into the gap 450, and into a faucet 310 mounted on the stem 400.

In an embodiment, syrup regulators 270 and tower circulation pump and motor 160 is set to maintain a carbonated water pressure approximately 10-15 pounds per square inch higher than the pressure of the syrup. Constant differential pressure helps prevent the fluids from mixing when faucet 310 is closed.

By way of example, the present disclosure operates when carbonator pump and motor 110 draws fresh water through cold water block 220 and pumps it into first carbonator tank 120. In an embodiment, carbon dioxide pressurized to a maximum of fifty pounds per square inch is infused into the water inside first carbonator tank 120 to create first-stage carbonated water. As shown in FIG. 3, circulating pump and motor 140 draws first-stage carbonated water from first carbonator tank 120 and pumps it back into first carbonator tank 120 and into second carbonator tank 150.

Pressurized carbon dioxide flows through carbonation stone 290 into the carbonated water inside second carbonator tank 150, creating second-stage carbonated water. Circulating pump and motor 140 draws second-stage carbonated water from second carbonator tank 150 and pumps it through cold water blocks 220 and back into first carbonator tank 120 and into second carbonator tank 150.

In an embodiment, controller 130 stops the operation of carbonator pump and motor 110 when the water level inside first carbonator tank 120 reaches a predetermined high level. At such time, second carbonator tank 150 may be unfilled by approximately one-half gallon given the volume difference between first carbonator tank 120 and second carbonator tank 150. Circulating pump and motor 140 continues to circulate carbonated water to increase the carbonation level of the water and facilitate a preferable mixture of first and second stage carbonated water. After approximately twenty minutes, controller 130 stops the operation of circulating pump and motor 140 because the carbonation level and quality may be ideal. It should be noted that the carbonation level and quality may be adjusted by changing the run time and operation time intervals of circulating pump and motor 140.

Tower circulation pump and motor 160, draws second-stage carbonated water from second carbonator tank 150 and pumps it through cold water blocks 220 and into manifold 171 within brix capacitor 170. Second-stage carbonated water flows from manifold 171 to faucets 310 within beverage dispensing tower 300, and it returns to the suction side of tower circulation pump and motor 160, thereby continuously circulating through cold water blocks 220, manifold 171, and faucets 310.

An electrical diagram of controlled operation of the water carbonation and circulation system is depicted in FIG. 6. Internal sensor and flotation device 280 monitors the water level in first carbonator tank 120. When the water level in first carbonator tank 120 falls to a predetermined low level, internal sensor and flotation device 280 sends an electrical signal to controller 130 which activates carbonator pump and motor 110 to pump additional fresh water into first carbonator tank 120. When the water level in first carbonator tank 120 fills to a predetermined high level, internal sensor and flotation device 280 sends an electrical signal to controller 130, which deactivates carbonator pump and motor 110 to ensure first carbonator tank 120 is not over-filled.

Controller 130 activates circulating pump and motor 140 after it deactivates carbonator pump and motor 110. A timing circuit in controller 130 ceases power to circulating pump and motor 140 after a set amount of time, which is adjustable within controller 130. Consequently, circulating pump and motor 140 operates only when the system demands fresh carbonate product, which prevents over-carbonation of the carbonated water and helps eliminate excessive foaming of the final mixed beverage upon dispensation.

The continuous flow of carbonated water helps the water carbonate more quickly than stagnant water and it helps preserve carbonation. Constant flow of carbonated water through cold water blocks 220 also helps to maintain a uniform low temperature, which promotes faster and more efficient absorption of carbon dioxide than ambient temperature water. As a result, the system maintains a reserve of low-pressure, refrigerated carbonated water from which it may draw at any time.

Syrup pump 260 draws syrup from syrup sources 210 and pumps the syrup through a plurality of tubing lines into brix capacitor 170 at a flow rate and pressure set by syrup regulators 270. The flow rate and pressure of the syrup is further controlled by flow control valves 172 displaced within brix capacitor 170. The syrup flows downstream from brix capacitor 170 into faucets 310 displaced along the lateral housing 302 of beverage dispensing tower 300.

To dispense a mixed beverage, a consumer moves handle lever 314 to the open position. Internal plunger 315 unseats from seat 316. Carbonated water and syrup are mixed as they flow at approximately equal pressures through conical flow guide 317 and into a target container.

Dispensing refrigerated carbonated water and syrup at fifty pounds per square inch, which is relatively low compared with industry-standard fountain machines, provides an advantage. State of the art technology employs a much higher-pressure carbonation system to maintain a desired carbonation range due to carbonated water stagnation and ambient temperature fluid storage. Typical fountain machines also do not employ refrigeration and continuous carbonated water circulation to maintain optimal carbonation and low-temperature fluids. Such high-pressure carbonated water dispenses at a high flow rate which creates a precipitous temperature drop, creates turbulent flow and results in excessive foaming. Mixing ambient temperature carbonated water and syrup at such pressures further exacerbates foaming. Excessive foaming causes the beverage to quickly “go flat” and lose consumer appeal. In contrast, carbonated water stored an optimal carbonation level, at low pressure and temperature dispenses at a relatively low flow rate which creates laminar flow, thereby significantly reducing foaming and creating a more desirable beverage.

For the purposes of promoting and understanding of the principles of the disclosure, reference has been made to the embodiments illustrated in the drawings, and specific language has been used to describe these embodiments. However, it will be apparent to those skilled in the art that various modifications and variations are possible while preserving the spirit and scope of the disclosure. Accordingly, the specific language herein intends no limitation of the scope of the disclosure, and the disclosure should be construed to encompass all embodiments that would normally occur to one of ordinary skill in the art.

What is claimed is:

1. A soda dispenser comprising:
a stem comprising:
a first opening on a first end of the stem;
a second opening on a second end of the stem; and
a central bore connecting the first opening of the stem and the second opening of the stem; and
a flow restrictor comprising:
an opening on a first end of the flow restrictor;
a cap on a second end of the flow restrictor;
a central portion between the first end of the flow restrictor and the second end of the flow restrictor, wherein the central portion and the cap define a hollow interior of the flow restrictor; and
a plurality of holes provided around a perimeter of the flow restrictor; and
a faucet fixed to the second end of the stem,
wherein the stem is configured to receive carbonated water at the first end of the stem,
wherein the flow restrictor is at least partially within the second end of the stem and is configured to receive the carbonated water into the hollow interior of the flow restrictor from the stem through the opening on the first end of the flow restrictor, and
wherein the plurality of holes are configured to allow the carbonated water received into the hollow interior of the flow restrictor to exit the flow restrictor into a gap formed between an outer surface of the flow restrictor and an inner surface of the stem.

2. The soda dispenser of claim 1, further comprising:
a housing;
at least one source of carbonated water; and
a soda delivery line connected to the at least one source of carbonated water,
wherein the stem is attached to the housing and receives the carbonated water from the soda delivery line, and
wherein the faucet comprises a first input configured to receive the carbonated water from the stem.

3. The soda dispenser of claim 2, further comprising at least one source of syrup, wherein the faucet comprises an input connected to the at least one source of syrup.

4. The soda dispenser of claim 1, further comprising at least one source of carbonated water and at least one source of syrup,
wherein the stem is connected to the at least one source of carbonated water, and
wherein the faucet comprises a first input connected to the stem and configured to receive the carbonated water from the stem, and a second input connected to the at least one source of syrup.

5. The soda dispenser of claim 3, where the syrup is delivered to the faucet at a lower pressure than a pressure that the carbonated water is delivered to the faucet.

6. The soda dispenser of claim 3, wherein the faucet comprises a valve and a flow guide with an exterior and an interior.

7. The soda dispenser of claim 6, wherein the syrup and the carbonated water are mixed on the interior of the flow guide when the valve is opened.

8. The soda dispenser of claim 1, wherein the plurality of holes are evenly distributed around the perimeter of the flow restrictor.

9. The soda dispenser of claim 1, wherein a number of the plurality of holes is 3.

10. The soda dispenser of claim 1, wherein a number of the plurality of holes is 6.

11. A soda dispenser comprising:
a stem comprising a central bore, wherein the stem is configured to receive carbonated water;
a flow restrictor inside the central bore, the flow restrictor comprising an opening facing an interior of the stem and a plurality of holes distributed around a perimeter of the flow restrictor; and
a faucet attached to an end of the stem downstream from the flow restrictor,
wherein the flow restrictor is configured to restrict a flow of carbonated water through the stem by partially blocking the central bore, and
wherein the plurality of holes are configured to allow the carbonated water received into the flow restrictor through the opening facing the interior of the stem to return to the central bore.

12. The soda dispenser of claim 11, wherein the plurality of holes are evenly distributed around the perimeter of the flow restrictor.

13. The soda dispenser of claim 11, wherein a number of the plurality of holes is 3.

14. The soda dispenser of claim 11, wherein a number of the plurality of holes is 6.

15. A soda dispenser comprising:
at least one source of carbonated water;
at least one source of syrup;
a housing;
a soda delivery line connected to the at least one source of carbonated water,
a stem comprising:
a first opening on a first end of the stem, wherein the first opening is connected to the soda delivery line;
a second opening on a second end of the stem; and
a central bore connecting the first opening of the stem and the second opening of the stem; and
a flow restrictor comprising:
an opening on a first end of the flow restrictor;
a cap on a second end of the flow restrictor;
a central portion between the first end of the flow restrictor and the second end of the flow restrictor, wherein the central portion and the cap define a hollow interior of the flow restrictor; and
a plurality of holes provided around a perimeter of the flow restrictor; and
a faucet fixed to the second end of the stem,
wherein the flow restrictor is at least partially within the stem and is configured to receive, from the stem, carbonated water, and
wherein the plurality of holes are configured to allow the carbonated water to move from the hollow interior of the flow restrictor into a gap formed between an outer surface of the flow restrictor and an inner surface of the stem.

16. The soda dispenser of claim 15, wherein the faucet comprises an input connected to the at least one source of syrup.

17. The soda dispenser of claim 15, wherein the faucet comprises a first input connected to the stem and configured to receive the carbonated water from the stem, and a second input connected to the at least one source of syrup.

18. The soda dispenser of claim 17, where the syrup is delivered to the faucet at a lower pressure than a pressure that the carbonated water is delivered to the faucet.

19. The soda dispenser of claim 17, wherein the faucet comprises a valve and a flow guide with an exterior and an interior.

20. The soda dispenser of claim 19, wherein the syrup and the carbonated water are mixed on the interior of the flow guide when the valve is opened.
